(19) United States
(12) Patent Application Publication
(10) Pub. No.: US 2014/0268173 A1
(43) Pub. Date: Sep. 18, 2014

(54) SHAPE MEASUREMENT APPARATUS, MEASUREMENT METHOD, AND METHOD OF MANUFACTURING ARTICLE

(71) Applicant: CANON KABUSHIKI KAISHA, Tokyo (JP)

(72) Inventor: Takanori UEMURA, Saitama-shi (JP)

(73) Assignee: CANON KABUSHIKI KAISHA, Tokyo (JP)

(21) Appl. No.: 14/190,393

(22) Filed: Feb. 26, 2014

(30) Foreign Application Priority Data
Mar. 14, 2013 (JP) 2013-052428

(51) Int. Cl. G01B 11/24

(52) U.S. Cl. CPC G01B 11/2441
USPC 356/511

(57) ABSTRACT

An apparatus measures a shape of an object by detecting interfering light between reference light and test light. The apparatus includes a detector configured to detect the interfering light, an optical member located between the object and the detector and including a light attenuating part, and an adjusting unit configured to adjust a relative position and/or angle between the optical member and an optical path of the test light. A part of the test light from a second region, having surface roughness smaller than that of a first region in the region including the measured region of the object is attenuated by the light attenuating part. The detector detects interfering light between the reference light and test light from the first region and the second region after passing through the optical member.

### BACKGROUND OF THE INVENTION

1. Field of the Invention

The present invention relates to a measurement apparatus and measurement method for measuring the shape of an object to be measured, and a method of manufacturing an article.

2. Description of the Related Art

U.S. Pat. No. 7,986,414 and Japanese Patent Laid-Open No. 2006-17613 disclose measurement apparatuses which measure the three-dimensional shape of an object to be measured. The measurement apparatus described in U.S. Pat. No. 7,986,414 measures the height of an object to be measured by using an interference measurement principle of scanning the frequency. The measurement apparatus described in Japanese Patent Laid-Open No. 2006-17613 measures the height of an object to be measured by using a contactless light wave interference measurement principle. In these measurement apparatuses, a problem occurs when regions having greatly different reflectances coexist in the same field of view, for example, when an object to be measured and a support table supporting it are measured at once. In such a case, the sensitivity of a camera which detects interfering light needs to be set so that a portion at which the reflectance and light intensity are high is not saturated. In a region where the light intensity is low, no satisfactory camera resolution is obtained, the influence of noise is great, and high-accuracy measurement becomes difficult. To solve this problem, the measurement apparatus described in Japanese Patent Laid-Open No. 2006-17613 adjusts the sensitivity of a detector for an incident light amount or interfering light to acquire a plurality of images, and acquires information about an interfering signal from images which are different between respective regions.

However, the measurement apparatus described in Japanese Patent Laid-Open No. 2006-17613 takes time for measurement because images need to be acquired under different conditions for respective regions having different reflectances. Especially when many interfering signal images need to be acquired to measure the height of an object to be measured, as in the measurement apparatus described in U.S. Pat. No. 7,986,414, if measurement is performed while changing the conditions between respective regions, measurement takes a long time.

### SUMMARY OF THE INVENTION

The present invention provides a technique of quickly measuring the shape of an object to be measured at high accuracy even when regions having greatly different reflectances coexist in the same field of view.

The present invention provides in its first aspect an apparatus for measuring a shape of a measured region of an object to be measured, by detecting interfering light between reference light from a reference surface and test light from a region including the measured region of the object to be measured, comprising: a detector configured to detect the interfering light; an optical member located between the object to be measured and the detector and including a light attenuating part; and an adjusting unit configured to adjust a relative position and angle between the optical member and an optical path of the test light entering the optical member, the relative position, or the angle, wherein a part of the test light from a second region, having surface roughness smaller than that of a first region in the region including the measured region of the object to be measured, is attenuated by the light attenuating part due to the adjustment by the adjusting unit, and wherein the detector detects interfering light between the reference light and test light from the first region and the second region after passing through the optical member.

The present invention provides in its second aspect a method of measuring, by using a measurement apparatus, a shape of a measured region of an object to be measured, by detecting interfering light between reference light from a reference surface and test light from a region including the measured region of the object to be measured, the measurement apparatus including: a detector configured to detect the interfering light; an optical member located between the object to be measured and the detector and including a light attenuating part; and the region including the measured region of the object to be measured including a first region and a second region having surface roughnesses smaller than that of a first region, the method comprising: a step of adjusting a relative position and angles between the optical member and an optical path of the test light entering the optical member, the relative position, or the angle, a step of detecting, after the adjusting step, interfering light between the reference light and test light from the first region and the second region after passing through the optical member, wherein a part of the test light from the second region is attenuated by the light attenuating part due to the adjusting step.

The present invention provides in its third aspect a method of manufacturing an article, comprising the steps of: measuring a shape of a surface to be measured of an article by using an apparatus defined in the first aspect; and processing the surface to be measured, based on the measured shape, to manufacture the article.

Further features of the present invention will become apparent from the following description of exemplary embodiments with reference to the attached drawings.

### BRIEF DESCRIPTION OF THE DRAWINGS

FIG. 1 is a view showing a measurement apparatus according to the first embodiment;

FIGS. 2A to 2C are views for explaining an adjusting unit according to the first embodiment;

FIGS. 3A to 3C are views for explaining adjustment by the adjusting unit according to the first embodiment;

FIG. 4 is a graph showing the relationship between the tilting angle and a change of the intensity of light having passed through a stop;

FIG. 5 is a view showing a measurement apparatus according to the second embodiment;

FIGS. 6A to 6C are views for explaining an adjusting unit according to the second embodiment;

FIGS. 7A to 7C are views for explaining adjustment by the adjusting unit according to the second embodiment;

FIG. 8 is a graph showing the relationship between the stop moving amount and a change of the intensity of light having passed through a stop; and

FIG. 9 is a view showing another example of the stop.

### DESCRIPTION OF THE EMBODIMENTS

Embodiments of the present invention will now be described in detail with reference to the accompanying drawings.

### First Embodiment

FIG. 1 is a schematic view showing a measurement apparatus 10 according to the first embodiment. The measurement apparatus 10 according to the first embodiment includes an interferometer capable of scanning the frequency. The interferometer is configured to measure the three-dimensional shape of an object to be measured as point cloud data. The interferometer capable of scanning the frequency includes a coherent light source capable of changing the frequency, an interfering optical system capable of branching and coupling light from the coherent light source to generate interfering light, and a detector which detects interfering light. The interferometer which scans the frequency acquires an interfering signal while scanning the frequency of coherent light, and calculates a distance based on a phase change of the interfering signal. The interferometer is not limited to this interferometer which scans the frequency, but can be a well-known interferometer. Examples are a multi-wavelength interferometer which generates a synthetic wavelength from beams of different wavelengths, and a white light interferometer which uses, as the light source, a low-coherent light source such as a white light LED.

A light source 101 having interference is a coherent light source capable of scanning the frequency in a predetermined range. As the light source 101, for example, a semiconductor laser (ECDL) using an external resonator, or a full-band tunable DFB laser is usable. The light source 101 is connected to a digital-to-analog converter 102. The output frequency of the light source 101 is controlled by adjusting a current value which is supplied from the digital-to-analog converter 102 to the light source 101.

Light emitted by the light source 101 is guided to a beam splitter 103. One beam branched by the beam splitter 103 is guided to a frequency measurement unit 104. The frequency measurement unit 104 can measure the frequency of light emitted by the light source 101. The frequency measured by the frequency measurement unit 104 is transferred to a calculation unit 150. The frequency measurement unit 104 is not always indispensable. The frequency measurement unit 104 can be omitted as long as the light source 101 can scan the frequency to a desired one at high accuracy without measuring the frequency.

After the beam diameter of the other beam branched by the beam splitter 103 is enlarged by lenses 105 and 106, the beam is guided to a λ/2 plate 107. The λ/2 plate 107 is rotatable by a rotation mechanism (not shown). The light source 101 emits linearly polarized light. The polarization direction of light having passed through the λ/2 plate 107 can be adjusted in an arbitrary direction in accordance with the rotation angle of the λ/2 plate 107. A polarization beam splitter 108 is located behind the λ/2 plate 107. The branch ratio of transmitted light and reflected light can be changed in accordance with the rotation angle of the λ/2 plate 107.

The light which has entered the polarization beam splitter 108 is branched into reference light 121 and test light 122 having polarization directions perpendicular to each other. The reference light 121 passes through a λ/4 plate 109a and is guided to a reference mirror (reference surface) 110. The test light 122 passes through a λ/4 plate 109b and is guided to a region including the measured region of an object 170 to be measured. A support table 172 supports the object 170 to be measured. A tilting mechanism (adjusting unit) 180 which tilts the support table can tilt the support table 172 with respect to the optical axis of an optical system 114a. A control unit C controls the tilting angle (adjustment parameter) of the tilting mechanism 180 with respect to the optical axis of the optical system 114a. Details of the tilting mechanism 180 will be described later.

The light reflected or scattered by the measured region of the object 170 to be measured and the support table 172 passes again through the λ/4 plate 109b and is guided to the polarization beam splitter 108. Similarly, the light reflected by the reference mirror 110 passes again through the λ/4 plate 109a and is guided to the polarization beam splitter 108. After the reference light 121 and test light 122 pass twice through the corresponding λ/4 plates, both of their polarization directions rotate by 90°. The reference light 121 is reflected by the polarization beam splitter 108, and the test light 122 passes through the polarization beam splitter 108. Then, both the reference light 121 and test light 122 are guided toward the optical system 114a. Accordingly, the reference light 121 and test light 122 are spatially superimposed.

The light superimposed again by the polarization beam splitter 108 is condensed by the optical system 114a. The front focus of the optical system 114a is set to be near the object 170 to be measured. With this setting, the object 170 to be measured is imaged on a first detector 131 and second detector 132 without a blur. A stop 115 (optical member) is located near the rear focus of the optical system 114a. The stop 115 includes a light shielding member (light attenuating part) and an aperture (light transmission part). The optical system 114a constructs an optical system which condenses the test light 122 to the stop 115. The optical system 114a also constructs an imaging optical system which images the object 170 to be measured on the first and second detectors 131 and 132 together with an optical system 114b (to be described later). When an iris diaphragm is used as the stop 115, the light amount, depth of field, and speckle size can be adjusted by adjusting the diameter of the iris diaphragm.

The light having passed through the stop 115 is condensed by the optical system 114b, reflected by the wavelength filter 117, and guided to a polarizer 116. The transmission axis of the polarizer 116 is located at 45° with respect to the polarization direction of the reference light 121 and test light 122. Hence, the reference light 121 and test light 122 interfere with each other, generating interfering light 123. The measurement apparatus 10 includes the first detector 131 and second detector 132. The interfering light 123 is reflected by a wavelength filter 117, and guided to the first detector 131 to measure the light intensity. The first detector 131 is, for example, a CCD or CMOS. An image measured by the first detector 131 is transferred to the calculation unit 150.

Letting ΔF be the total scanning amount of the frequency, c be the light speed, and Δφ be the phase change amount of the interfering signal, an optical path length difference L between a region including the measured region of the object 170 to be measured and the support table 172, and the reference mirror 110 is given by:

L=cΔφ/4πΔF (1)

The interferometer which scans the frequency can obtain the optical path length difference by scanning the frequency of the light source 101 to measure the interfering signal, and calculating the phase change amount. The measurement apparatus 10 scans the frequency of the light source 101, and the first detector 131 acquires a plurality of images. The acquired images are transferred to the calculation unit 150 to analyze the interfering signal, thereby calculating the optical path length difference. The calculation unit 150 processes the interfering signal for each pixel of the first detector 131, and can acquire three-dimensional XYZ point cloud data.

The interferometer which scans the frequency needs to acquire a plurality of images in order to obtain information about the optical path length difference. The number of pixels of the detector and the frame rate have a tradeoff relationship. Therefore, to shorten the image acquisition time and shorten the time taken for measurement, a high-speed camera having a small number of pixels is used as the first detector 131.

Assume that a measured region (first region) 171 of the surface of the object 170 to be measured and a surface (second region) 173 of the support table 172 have different surface roughnesses. When the surface roughness is high, a speckle is generated upon irradiation with coherent light. When the frequency is scanned, the phase correlation drops at a portion where the light intensity of the speckle is low, and the measurement error becomes large. To prevent lowering of measurement reliability, data regarding a portion where the light intensity of the speckle is low is removed from three-dimensional point cloud data, thereby enhancing measurement reliability.

Since no clear image is obtained when the speckle exists, it is difficult to measure a dimension in a direction (lateral direction) perpendicular to the optical axis of the optical system 114a at high accuracy. Considering this, the measurement apparatus 10 adopts a light source 113 of incoherent light. The lateral dimension of the object 170 to be measured is calculated using an image obtained upon irradiation by the light source 113. The light source 113 includes a plurality of light source elements, and these light source elements are located in a ring shape. The light source element is, for example, an LED or lamp. The ON state of each light source element can be individually controlled. This implements illumination from a desired direction.

The light sources 113 and 101 output beams of different wavelengths. The wavelength filter 117 is designed to transmit light from the light source 113 and reflect light from the light source 101. Incoherent light emitted by the light source 113 is reflected or scattered by the object 170 to be measured, passes through the wavelength filter 117, and is formed into an image on the second detector 132. As a result, the two-dimensional image of the object 170 to be measured is acquired. The lateral dimension measurement accuracy depends on the camera resolution. Unlike the interfering signal, many two-dimensional images need not be acquired to measure the lateral dimension of the object 170 to be measured. Thus, a low-speed camera having a large number of pixels is used as the second detector 132. The two-dimensional image acquired by the second detector 132 is transferred to the calculation unit 150.

The adjusting unit according to the first embodiment will be explained with reference to FIGS. 2A to 2C, 3A to 3C, and 4. The adjusting unit adjusts at least the relative positions or angles of the optical path of the test light 122 from the object 170 to be measured to the stop 115 and the aperture of the stop 115. The adjusting unit according to the first embodiment is constructed as the tilting mechanism 180 which adjusts the relative angles by tilting the support table 172 with respect to the optical axis of the optical system 114a. FIGS. 2A to 2C are views for explaining the function of the tilting mechanism 180 serving as the adjusting unit according to the first embodiment. FIGS. 2A to 2C show only an extracted portion regarding adjustment of the angle by the tilting mechanism 180. The polarization beam splitter 108 and λ/4 plate 109b are not illustrated.

A case will be examined, in which the measured region 171 of the object 170 to be measured is a rough surface (Lambert reflecting surface) having a high surface roughness, and the surface 173 of the support table 172 is a specular surface (specular reflecting surface) having a low surface roughness. In this case, many components (scattered components) of light incident on the object 170 to be measured are scattered at a wide angle. To the contrary, many components (specularly reflected components) of light incident on the support table 172 are reflected in a direction in which the incident angle and reflection angle become equal to each other. The intensity distribution of scattered light depends on the surface roughness. On the Lambert reflecting surface having a high surface roughness, the intensity of scattered light is constant regardless of the angle.

In FIG. 2A, the tilting mechanism 180 does not tilt the support table 172, and the support table 172 and object 170 to be measured are perpendicular to the optical axis of the optical system 114a. In FIG. 2B, the tilting mechanism 180 tilts the support table 172, and the support table 172 and object 170 to be measured are tilted with respect to the optical axis of the optical system 114a. FIG. 2C is a view showing a state in which the tilting mechanism 180 further tilts the support table 172.

FIGS. 3A to 3C are views for explaining a principle of adjusting, by the tilting mechanism 180, the ratio of the intensity of test light traveling from the object 170 to be measured and the intensity of test light traveling from the support table 172 after passing through the stop 115. FIGS. 3A to 3C show the stop 115, and light 192, at the stop 115, of light specularly reflected by the support table 172. FIGS. 3A to 3C correspond to the states of the tilting mechanism 180 in FIGS. 2A to 2C, respectively.

In FIG. 3A, the support table 172 and object 170 to be measured have a posture perpendicular to the optical axis of the optical system 114a. Thus, the light 192 reflected by the support table 172 passes through the center of the aperture of the stop 115. In FIG. 3B, the support table 172 is tilted with respect to the optical axis of the optical system 114a. The light 192 reflected by the support table 172 is partially cut off by the stop 115. In FIG. 3C, the support table 172 is greatly tilted with respect to the optical axis of the optical system 114a. The light 192 reflected by the support table 172 is almost completely cut off by the stop 115.

FIG. 4 is a graph showing the relationship between the tilting angle of the support table 172 and object 170 to be measured and the intensity of light having passed through the stop 115. The intensity of the light 192 reflected by the support table 172 depends on the tilting angle of the support table 172, as represented by a broken line in the graph of FIG. 4. The intensity of specularly reflected light having passed through the stop 115 is constant from a state in which there is no tilt, as shown in FIG. 2A, up to a state in which cutoff of the reflected light 192 by the stop 115 starts. When the tilting angle becomes larger, the specularly reflected light 192 is partially cut off by the stop 115. Hence, the intensity of the specularly reflected light decreases as the tilting angle increases. When the tilting angle further increases, the light 192 specularly reflected by the support table 172 is almost completely cut off by the stop 115 and the light intensity becomes 0.

As for light 191 scattered by the object 170 to be measured, when the surface roughness of the object 170 to be measured is so large as to regard the surface as the Lambert reflecting surface, the intensity of light having passed through the stop 115 does not depend on the tilting angle, as represented by a solid line in the graph of FIG. 4. For this reason, the intensities of the light 192 reflected by the support table 172 and the light 191 scattered by the object 170 to be measured after passing through the stop 115 coincide with each other at a given tilting angle.

In this tilting angle state, the intensities of beams received by the first detector 131 from the regions of both the object 170 to be measured and support table 172 become equal to each other. As a result, a satisfactory camera resolution can be obtained without changing the image capturing conditions between the respective regions. The influence of noise on the interfering signal is reduced, and high-accuracy measurement becomes possible. Since images need not be acquired under different conditions between respective regions having different reflectances, measurement can be completed within a short time.

To decide an optimum tilting angle, it suffices to acquire data representing the relationship between the tilting angle, and the intensity of each of light reflected by the object 170 to be measured and light reflected by the support table 172 after passing through the stop 115, and to obtain an angle at which the intensities of these two reflected beams coincide with each other. In this case, it is desirable to detect the test light by the detector while the reference light 121 is shield or the light amount of the reference light 121 is decrease, compared to the test light 122, so as to neither generate an interfering signal nor change the light intensity on the detector. When a plurality of parts of the same model number are measured, it is also possible to store an optimum tilting angle in the apparatus in correspondence with the model number, and read out data in measurement. In this case, a measurement step for optimizing the tilting angle can be skipped.

As described above, even when regions having greatly different reflectances coexist in the same field of view, the measurement apparatus according to the first embodiment can measure the shape of an object to be measured at high accuracy in a short time. The case in which the surface roughness of the object 170 to be measured is higher than that of the support table 172 has been described above. However, the present invention is not limited to only this case and is also applicable to a case in which the surface roughness relationship is reversed. Note that the optical system which condenses test light to the stop may be omitted. Also, the measurement apparatus may not include the support table. In this case, a support table is prepared separately from a measurement apparatus including no support table, and the support table on which an object to be measured is set is irradiated with light to measure the shape of a surface to be measured.

### Second Embodiment

FIG. 5 is a schematic view showing a measurement apparatus 20 according to the second embodiment. The interferometer of the measurement apparatus 20 according to the second embodiment is a white light interferometer. The white light interferometer includes a light source which outputs low-coherent light, an interfering optical system which branches and couples light from the light source to generate interfering light, and a detector which detects interfering light. While scanning, along the optical axis, a stage on which an object to be measured is set, the white light interferometer acquires an interfering signal, and calculates a distance from the peak position of the interfering signal.

A light source 201 which emits low-coherent light, serving as a light source having interference, outputs light of a wide spectral range. As the light source 201, for example, a white light LED or lamp light source is available. After the beam diameter of light output from the light source 201 is enlarged by lenses 205 and 206, the light is guided to a beam splitter 208.

The light entering the beam splitter 208 is branched into reference light 221 and test light 222. The reference light 221 is guided to a reference mirror (reference surface) 210. The test light 222 is guided to an object 270 to be measured. The object 270 to be measured is set on a support table 211. The reference mirror 210 is movable along the optical axis by a Z-axis stage (not shown).

The light reflected or scattered by the object 270 to be measured is guided again to the beam splitter 208. Similarly, the light reflected by the reference mirror 210 is guided again to the beam splitter 208. The reference light 221 reflected by the beam splitter 208 and the test light 222 having passed through the beam splitter 208 are guided toward an optical system 214a. Accordingly, the reference light 221 and test light 222 are spatially superimposed, generating interfering light 223.

The light superimposed again by the beam splitter 208 is condensed by the optical system 214a. The front focus of the optical system 214a is set to be near the object 270 to be measured. With this setting, the object 270 to be measured is imaged on a detector 231 without a blur. A stop 215 is located near the rear focus of the optical system 214a. When an iris diaphragm is used as the stop 215, the light amount, depth of field, and speckle size can be adjusted by adjusting the diameter of the stop. A stop moving mechanism 280 serving as an adjusting unit can move the stop 215 in a direction crossing the optical axis of the optical system 214a. A control unit C controls the aperture position (adjustment parameter) of the stop 215 by the stop moving mechanism 280. Details of the stop moving mechanism 280 will be described later.

The light having passed through the stop 215 is condensed by an optical system 214b and is formed into an image on the detector 231. The detector 231 measures the light intensity of the interfering light 223. The detector 231 is, for example, a CCD or CMOS. An image measured by the detector 231 is transferred to a calculation unit 250. The white light interferometer can obtain the optical path length difference by scanning the reference mirror 210 along the optical axis by the Z-axis stage to measure the interfering signal, and calculating the peak position of the interfering signal. The measurement apparatus 20 moves the reference mirror 210 along the optical axis, and the detector 231 acquires a plurality of images. The acquired images are transferred to the calculation unit 250 to analyze the interfering signal, thereby calculating the optical path length difference. By processing the interfering signal for each pixel of the detector 231, three-dimensional XYZ point cloud data can be acquired.

Since no clear image is obtained when the speckle exists, it is difficult to measure a dimension in a direction (lateral direction) perpendicular to the optical axis at high accuracy. Considering this, the measurement apparatus 20 adopts a light source 213 of incoherent light. The lateral dimension of the object 270 to be measured is calculated using an image obtained upon irradiation by the light source 213. The light source 213 includes a plurality of light source elements, and these light source elements are located in a ring shape. The light source element is, for example, an LED or lamp. The ON state of each light source element can be individually controlled. This implements illumination from a desired direction.

The adjusting unit according to the second embodiment is the stop moving mechanism 280 which adjusts the relative positions of the optical path of the test light 222 and the aperture of the stop 215. The stop moving mechanism 280 according to the second embodiment will be explained with reference to FIGS. 6A to 6C, 7A to 7C, and 8. FIGS. 6A to 6C are views for explaining the function of the stop moving mechanism 280 serving as the adjusting unit according to the second embodiment. FIGS. 6A to 6C show only an extracted portion regarding adjustment by the stop moving mechanism 280. The beam splitter 208 and the like are not illustrated.

A case in which the object 270 to be measured has two surfaces having different surface roughnesses will be examined. A surface 271a of the object 270 to be measured is a rough surface having a high surface roughness, and a surface 271b of the object 270 to be measured is a specular surface having a low surface roughness. In this case, many components (scattered components) of light incident on the surface 271a are scattered at a wide angle. To the contrary, many components (specularly reflected components) of light incident on the surface 271b are reflected in a direction in which the incident angle and reflection angle become equal to each other. The intensity distribution of scattered light depends on the surface roughness. On the Lambert reflecting surface having a high surface roughness, the intensity of scattered light is constant regardless of the angle.

In FIG. 6A, the center of the aperture of the stop 215 coincides with the optical axis of the optical system 214a. In FIG. 6B, the stop moving mechanism 280 adjusts the position of the stop 215, and the center of the aperture of the stop 215 is decentered from the optical axis of the optical system 214a. FIG. 6C is a view showing a state in which the stop moving mechanism 280 further decenters the position of the stop 215 from the optical axis of the optical system 214a.

FIGS. 7A to 7C are views for explaining a principle of adjusting, by the stop moving mechanism 280 according to the second embodiment, the ratio of the intensity of light reflected by the surface 271a and the intensity of light reflected by the surface 271b after passing through the stop 215. FIGS. 7A to 7C show the stop 215, and light 292, on the stop surface, of light reflected by the surface 271b. FIGS. 7A to 7C correspond to the states of the stop moving mechanism 280 in FIGS. 6A to 6C, respectively.

In FIG. 7A, the center of the aperture of the stop 215 coincides with the optical axis of the optical system 214a. Thus, the light 292 reflected by the surface 271b passes through the center of the aperture of the stop 215. In FIG. 7B, the center of the aperture of the stop 215 is decentered from the optical axis of the optical system 214a. The light 292 reflected by the surface 271b is partially cut off by the stop 215. In FIG. 7C, the center of the aperture of the stop 215 is greatly decentered from the optical axis of the optical system 214a. Thus, the light 292 reflected by the surface 271b is almost completely cut off by the stop 215.

FIG. 8 is a graph showing the relationship between the moving amount of the center of the aperture of the stop 215 from the optical axis of the optical system 214a, and the intensity of test light having passed through the stop 215. The intensity of the light 292 reflected by the surface 271b depends on the moving amount, as represented by a broken line in the graph of FIG. 8. The light intensity is constant from a state in which there is no decentering, as shown in FIG. 6A, up to a moving amount at which part of the light 292 is cut off by the stop 215. When the moving amount becomes larger, the light 292 is partially cut off by the stop 215. Therefore, the light intensity decreases as the moving amount increases. When the moving amount further increases, the light 292 reflected by the surface 271b is almost completely cut off by the stop 215 and the light intensity becomes 0.

When the surface roughness of the surface 271a is so large as to regard the surface 271a as the Lambert reflecting surface, the intensity of the light 291 which has been scattered by the surface 271a and passed through the stop 215 does not depend on the moving amount of the stop 215, as represented by a solid line in the graph of FIG. 8. For this reason, the intensities of the light 292 reflected by the surface 271b and the light 291 scattered by the surface 271a after passing through the stop 215 coincide with each other at a given moving amount. Under this moving amount condition, the intensities of beams received by the detector 231 from the regions of both the surfaces 271a and 271b become equal to each other. As a result, a satisfactory camera resolution can be obtained without changing the image capturing conditions between the respective regions. The influence of noise on the interfering signal is reduced, and high-accuracy measurement becomes possible. Since images need not be acquired under different conditions between respective regions having different reflectances, measurement can be completed within a short time.

To decide an optimum moving amount, it suffices to measure, by the detector 231, the intensities of light scattered by the surface 271a and light reflected by the surface 271b while changing the moving amount, and to obtain a moving amount at which these intensities coincide with each other. In this case, it is desirable to cut off the reference light 221 or decrease the light amount of the reference light 221, compared to the test light 222, so as to neither generate an interfering signal nor change the light intensity. When a plurality of parts of the same model number are measured, it is also possible to store the moving amount of the stop 215 in the apparatus in correspondence with the model number, and read out data in measurement. In this case, a measurement step for optimizing the moving amount can be skipped. As described above, even when regions having greatly different reflectances coexist in the same field of view, the measurement apparatus according to the second embodiment can measure the shape of an object to be measured at high accuracy in a short time.

In the second embodiment, the stop 215 is constructed as a light-shielding member 215a having an aperture 215b. The stop moving mechanism 280 moves the light-shielding member 215a to adjust the relative positions of the optical path of test light and the aperture 215b. However, the stop 215 may be constructed by a plurality of movable blades 215c, as shown in FIG. 9. In the stop 215 of FIG. 9, the stop moving mechanism 280 moves at least one blade 215c to change the position of the aperture 215b. Further, the adjustment by the adjusting unit in the first embodiment and the adjustment by the adjusting unit in the second embodiment can be combined.

### Embodiment of Method of Manufacturing Article

A method of manufacturing an article in the embodiment is used to, for example, process an article such as a metal part (for example, a gear) or an optical element. The method of manufacturing an article according to the embodiment includes a step of measuring the shape of a surface to be measured of the article by using the above-described measurement apparatus, and a step of processing the surface to be measured, based on the measurement result in the measuring step. For example, the shape of the surface to be measured is measured using the measurement apparatus, and the surface to be measured is processed based on the measurement result so that the shape of the surface to be measured becomes a desired shape based on a design value or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-052428 filed Mar. 14, 2013, which is hereby incorporated by reference herein in its entirety.

1. An apparatus for measuring a shape of a measured region of an object to be measured, by detecting interfering light between reference light from a reference surface and test light from a region including the measured region of the object to be measured, comprising:
a detector configured to detect the interfering light;
an optical member located between the object to be measured and said detector and including a light attenuating part; and
an adjusting unit configured to adjust a relative position and angle between the optical member and an optical path of the test light entering the optical member, the relative position, or the angle, wherein a part of the test light from a second region, having surface roughness smaller than that of a first region in the region including the measured region of the object to be measured, is attenuated by the light attenuating part due to the adjustment by the adjusting unit, and
wherein said detector detects interfering light between the reference light and test light from the first region and the second region after passing through the optical member.

2. The apparatus according to claim 1, wherein a ratio of an intensity of the test light from the first region and an intensity of the test light from the second region, after passing through the optical member, is changed due to the adjustment by the adjusting unit.

3. The apparatus according to claim 1, wherein the optical member is a stop.

4. The apparatus according to claim 1, further comprising an optical system configured to condense the test light to said optical member.

5. The apparatus according to claim 1, further comprising a support table configured to support the object to be measured,
wherein said adjusting unit includes a tilting mechanism configured to adjust the angle by tilting said support table.

6. The apparatus according to claim 1, wherein said adjusting unit includes a moving mechanism configured to adjust the position by moving said optical member in a direction crossing the test light.

7. The apparatus according to claim 6, wherein said optical member includes a plurality of blades as the light attenuating part, and the moving mechanism changes the position by moving at least one of the plurality of blades.

8. The apparatus according to claim 5, wherein the first region includes the measured region of the object to be measured, and the second region includes a region of said support table.

9. The apparatus according to claim 1, wherein the first region includes a part of the measured region of the object to be measured, and the second region includes another part of the measured region of the object to be measured.

10. The apparatus according to claim 1, wherein the second region has a specular reflecting surface, and the first region has a Lambert reflecting surface.

11. A method of measuring, by using a measurement apparatus, a shape of a measured region of an object to be measured, by detecting interfering light between reference light from a reference surface and test light from a region including the measured region of the object to be measured, the measurement apparatus including:
a detector configured to detect the interfering light;
an optical member located between the object to be measured and the detector and including a light attenuating part; and
the region including the measured region of the object to be measured including a first region and a second region having surface roughnesses smaller than that of a first region, the method comprising:
a step of adjusting a relative position and angles between the optical member and an optical path of the test light entering the optical member, the relative position, or the angle,
a step of detecting, after the adjusting step, interfering light between the reference light and test light from the first region and the second region after passing through the optical member,
wherein a part of the test light from the second region is attenuated by the light attenuating part due to the adjusting step.

12. The method according to claim 11, further comprising:
a step of obtaining data representing a relationship between an intensity of each of a test light from the first region and a test light from the second region after passing through the optical member, and at least one of the position and the angle;
a changing step of adjusting at least one of the position and the angle based on the obtained data, and changing a ratio of the intensity of the test light from the first region and the intensity of the test light from the second region after passing through the optical member; and
a step of detecting interfering light between the reference light and the test light from the first region and the second region by using the detector after the changing step, to measure the shape of the measured region.

13. The method according to claim 11, wherein the data is obtained by detecting the test light by the detector while the reference light is shielded.

14. A method of manufacturing an article, comprising the steps of:
measuring a shape of a surface to be measured of an article by using an apparatus for measuring a shape of a measured region of an object to be measured, by detecting interfering light between reference light from a reference surface and test light from a region including the measured region of the object to be measured, comprising:
a detector configured to detect the interfering light;
an optical member located between the object to be measured and said detector and including a light attenuating part; and
an adjusting unit configured to adjust a relative position and angle between the optical member and an optical path of the test light entering the optical member, the relative position, or the angle, wherein a part of the test light from a second region, having surface roughness smaller than that of a first region in the region including the measured region of the object to be measured, is attenuated by the light attenuating part due to the adjustment by the adjusting unit, and
wherein said detector detects interfering light between the reference light and test light from the first region and the second region after passing through the optical member; and
processing the surface to be measured, based on the measured shape, to manufacture the article.
